(19) United States
(12) Patent Application Publication
(10) Pub. No.: US 2025/0037295 A1
(43) Pub. Date: Jan. 30, 2025

(54) Methods And Systems For Use In Processing Image Data Containing Position Data

(71) Applicant: MONSANTO TECHNOLOGY LLC, Saint Louis, MO (US)

(72) Inventors: Chethana GORIGA, Chesterfield, MO (US); Anthony James JONES, Saint Louis, MO (US); Jeremy Joshua PITTMAN, Ardmore, OK (US)

(21) Appl. No.: 18/784,632

(22) Filed: Jul. 25, 2024

Related U.S. Application Data
(60) Provisional application No. 63/529,327, filed on Jul. 27, 2023.

(51) Int. Cl. G06T 7/60; A01G 22/20; G06T 7/50; G06T 7/73; G06V 10/25; G06V 10/82

(52) U.S. Cl. CPC G06T 7/60; A01G 22/20; G06T 7/50; G06T 7/73; G06V 10/25; G06V 10/82; G06T 2207/20084; G06T 2207/30188

(57) ABSTRACT

Systems and methods for processing image data for crops are provided. One example computer-implemented method includes accessing image data specific to a corn plant, where the image data includes an image of the corn plant and depth data indicative of a range between the corn plant and a camera, which captures said image, and identifying, by a computing device, using a trained model, a feature of the corn plant, the feature including an ear of the corn plant and/or a node from which the ear emerges. The method also includes transforming, by the computing device, coordinates specific to the feature into a height of the feature of the corn plant and storing, by the computing device, the height of the feature of the corn plant in a memory.

### CROSS-REFERENCE TO RELATED APPLICATION

This application claims the benefit of, and priority to, U.S. Provisional Application No. 63/529,327, filed Jul. 27, 2023. The entire disclosure of the above application is incorporated herein by reference.

### FIELD

The present disclosure generally relates to methods and systems for use in processing image data for crops, where the image data includes relative position data, whereby positions of specific features related to the crops may be determined.

### BACKGROUND

This section provides background information related to the present disclosure which is not necessarily prior art.

Crops are planted, grown and harvested from various growing spaces. In connection with breeding, or testing of certain crops, different features of the crops may be measured. For example, yield, in bushels per acre, may be determined at harvest as a performance metric of the crop. Likewise, the height of the crop, root strength, or other suitable phenotypic trait, etc., may be determined or measured before, during or after growth of the crops in the growing spaces. Breeding may be employed, then, based on the measured data, to advance crops having desirable performance and/or phenotypic traits.

### SUMMARY

This section provides a general summary of the disclosure and is not a comprehensive disclosure of its full scope or all its features.

Example embodiments of the present disclosure generally relate to computer-implemented methods for processing image data for crops, including relative position data, whereby positions of specific features related to the crops may be determined. In one example embodiment, such a method generally includes: accessing image data specific to a corn plant, the image data including an image of the corn plant and depth data indicative of a range between the corn plant and a camera, which captures said image; accessing image data specific to a corn plant, the image data including an image of the corn plant and depth data indicative of a range between the corn plant and a camera, which captures said image; identifying, by a computing device, using a trained model, a feature of the corn plant, the feature including an ear of the corn plant and/or a node from which the ear emerges; transforming, by the computing device, coordinates specific to the feature into a height (or size) of the feature of the corn plant; and storing, by the computing device, the height (or size) of the feature of the corn plant in a memory.

In another example embodiment, a method for use in processing image data for crops includes accessing image data specific to a plant, the image data including an image of the plant and depth data indicative of a range between the plant and a camera, which capture said image; identifying, by a computing device, using a trained model, a feature of the plant; transforming, by the computing device, coordinates specific to the feature into a dimension of the feature of the plant; and storing, by the computing device, the dimension of the feature of the plant in a memory.

Example embodiments of the present disclosure also relate to non-transitory computer-readable storage media including executable instructions for processing image data. In one example embodiment, such a non-transitory computer-readable storage medium includes executable instructions, which when executed by at least one processor, cause the at least one processor to perform the operations described herein.

Example embodiments of the present disclosure also relate to systems for use in processing image data for crops, which includes relative position data, whereby positions of specific features related to the crops are determined. In one example embodiment, such a system generally includes at least one computing device, which is configured to perform the operations described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for processing image data for crops, where the image data includes relative position data, whereby positions of specific features related to the crops may be determined.

FIG. 2 is an example image of a plot that includes a corn crop, with multiple features of the corn crop identified.

FIG. 3 is an example input image and output data from a trained model appended to (or overlaid on) the input image, to identify nodes and/or ears of corn with a detection confidence, which may be provided from the system of FIG. 1;

FIG. 4 illustrates indication of variables employed in transforming coordinate data, as provided in the system of FIG. 1;

FIG. 5 is a block diagram of an example computing device that may be used in the system of FIG. 1; and

FIG. 6 illustrates a flow diagram of an example method, which may be used in (or implemented in) the system of FIG. 1, for use in processing image data for crops, which includes relative position data, whereby positions of specific features related to the crops are determined.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

For particular assessments of crops, such as, for example, ear height (or ear size) for corn crops, the assessment is accomplished manually, whereby a person enters a growing space and measures the ear height on each corn plant and records the information to a log. Beyond the labor intensity and the lack of scalability of the manual measurement processes, the precision and objectivity of the assessment may be reduced by the subjective nature of the person performing the assessment, whereby the data generated by the assessments may be corrupt and/or may introduce error into subsequent decisions or process dependent on the data. Providing for precision and objectivity, while also providing for scalability as well as reduced and/or elimination of manual processing, prior to the present disclosure, was beyond conventional technologies.

Uniquely, the systems and methods herein process image data for crops, where the image data includes relative position data, such that positions of specific features related to the crops may be determined (e.g., in some embodiments in an automated manner; in some embodiments independent of and/or free of and/or without manual measurement and/or assessment; etc.).

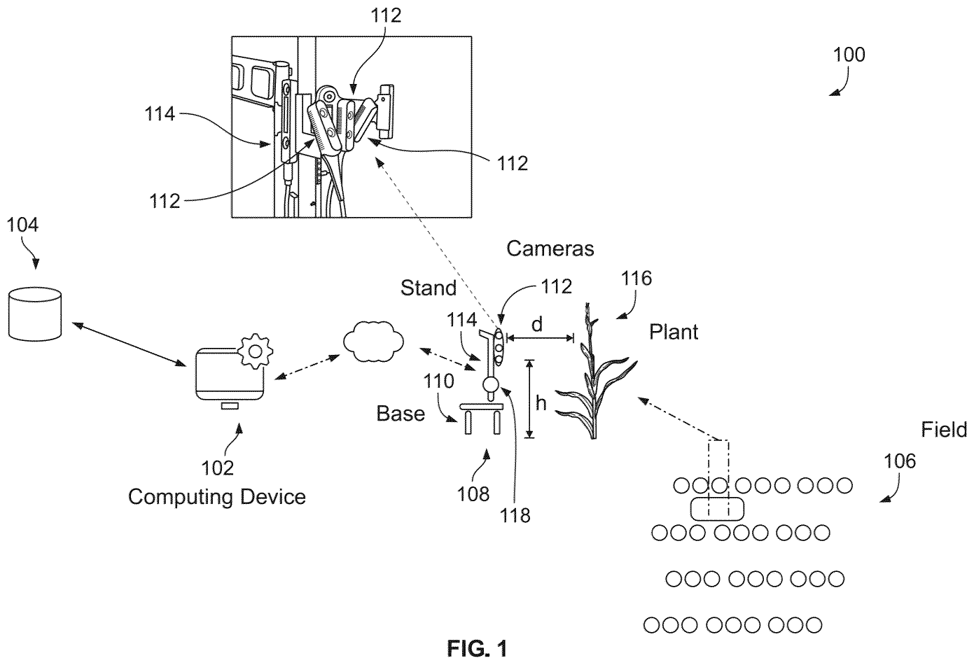

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, sources and/or types of image data, arrangements of fields, types of capture devices used to capture images of crops in fields, types of crops in the fields, etc.

In the example embodiment of FIG. 1, the system 100 generally includes a computing device 102 and a database 104, which is coupled to (and/or otherwise in communication with) the computing device 102, as indicated by the arrowed line therebetween. The computing device 102 is illustrated as separate from the database 104 in FIG. 1, but it should be appreciated that the database 104 may be included, in whole or in part, in the computing device 102 in other system embodiments.

The system 100 also includes a field 106, which includes rows of crops (e.g., four rows in FIG. 1, etc.), where each corn plant is indicate by a circle. Despite the limited illustration in FIG. 1, the field 106 generally covers several acres (e.g., 1 acre, 10 acres, 50 acres, 100 acres, or more or less, etc.), and rows are included throughout the field 106 (such that the field 106 will typically include multiple rows (e.g., more than the illustrated four, etc.) (but this is not required in all embodiments, whereby in some embodiments, the field 106 may include less than four rows, etc.)). It should also be understood that the field 106 may be any growing space, from a small test plot, to a greenhouse, to a larger commercial region covering many acres, etc.

In addition to the above, it should further be appreciated that while the field 106 is described as including multiple rows of corn, other plants and/or other varieties or types of plants may be included in the field 106 or in other fields in the system 100, etc.

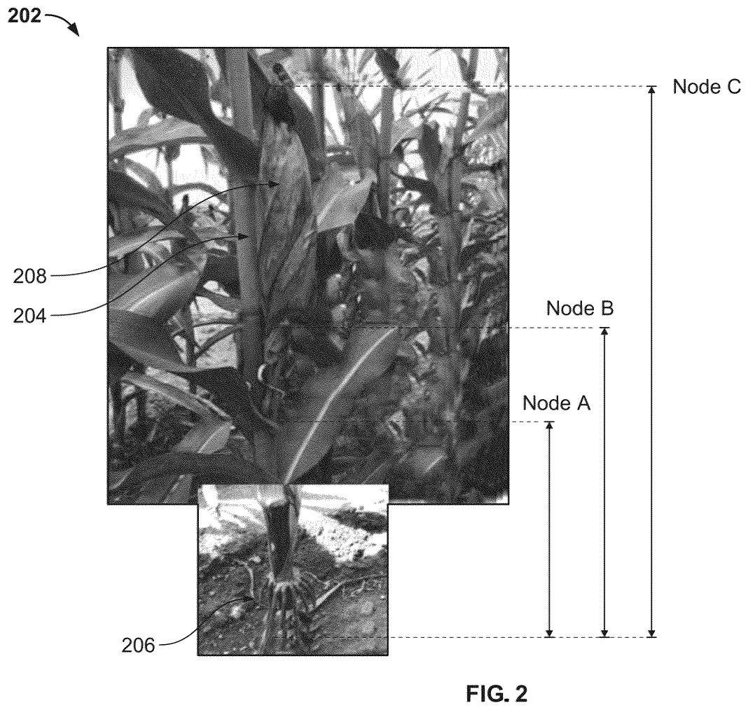

That said, an example corn plant 202 is illustrated in FIG. 2, where the plant 202 includes a stalk 204, a brace root 206 and an ear of corn 208. As further shown, the ear 208 is illustrated relative to nodes A, B and C. Node A denotes the node of the ear of corn 208, while node B denotes the bottom of the ear of corn 208 and the node C denotes the top of the ear of corn 208. As indicated, the nodes are each at a height from the brace root 206, or ground in which the corn plant is grown. The ear height then, for example, may include the distance between the node from which the ear emerges and the ground (i.e., the ground to node A in FIG. 2). Alternatively, the ear height may include a size of the ear of corn, for example, from the node to a tip of the ear. It should be appreciated that each corn plant illustrated in FIG. 1 includes the same nodes for each ear of corn.

With reference again to FIG. 1, system 100 further includes a surveyor computing device 108. The surveyor computing device 108 is illustrated in FIG. 1 as being separate from the computing device 102 and the database 104, in this example embodiment. That said, it should be appreciated that in one or more other embodiments, the surveyor computing device 108 may include, in whole or in part, the computing device 102 and/or the database 104.

The surveyor computing device 108, as shown, in this embodiment, is configured to move between the rows of corn in the field 106. As such, the surveyor computing device 108 defines dimensions, and in particular, a width that is compatible with the field 106, and other fields, and plants and/or rows in the field 106, etc. The surveyor computing device 108 includes a base 110, which, in turn, includes tracks, wheels, etc. (broadly, a transport mechanism or device), to enable the surveyor computing device 108 to move (e.g., to move the device 108, etc.) between and/or along two (or more) rows of corn in the field 106. In other example embodiments, the surveyor computing device 108 may be stationary in the field 106 (e.g., where the field includes a greenhouse, etc.) and the corn plants may move by the stationary surveyor computing device 108 (e.g., where the corn plants are positioned on conveyors in the greenhouse, etc.).

In this example embodiment, the surveyor computing device 108 also includes multiple cameras 112, which are mounted on a stand 114 that extends upward from the base 110 of the surveyor computing device 108. What's more, the cameras 112 are each mounted to the stand 114, in this example, at a particular height from the ground (e.g., height h in FIG. 1, etc.), where the height is known to the surveyor computing device 108. As shown in the detail view in FIG. 1, in this example embodiment, the surveyor computing device 108 includes three cameras 112, each disposed at a different orientation relative to the stand 114, thereby defining different angles relative to the stand 114. In this manner, one camera 112 generally points downward, one camera 112 generally point horizontally, and one camera 112 generally points upward. For example, the cameras 112 may be disposed at sufficient angles to provide for sufficient overlap between images captured, such as, for example, about fifteen degrees, about thirty degrees, about forty-five degrees, etc. of overlap. In one particular example, the cameras 112 may be disposed at different angles, relative to one another, including, specifically, a center camera 112 arranged at an angle of about 90 degrees from the long axis defined by the standard 114, and two other cameras 112 in this embodiment defining an angle of about ±35 degrees offset from the center camera 112 (e.g., one tilted upward about 35 degrees and one tilted downward about 35 degrees, etc.), etc. That said, it should be appreciated that the cameras 112 may be arranged at other angles, for example, relative to each other and/or relative to the stand 114, the ground, the crop, etc. in other examples. As such, the cameras 112 are configured to capture images of the corn crop in the field 106, and generally, substantially all of the corn crop (e.g., from brace root to tip/tassel, etc.).

Additionally, in this embodiment, each of the cameras 112 is configured to capture color spectrum data and depth of an object, i.e., the camaras 112 are depth cameras or stereo vision cameras, etc. An example depth camera that may be used herein includes a REALSENSE depth camera by INTEL CORPORATION. The cameras 112 may each include, for example, the INTEL RealSense™ D435i or ZED 2i depth camera, which provides RGB plus depth information and inertial measurement unit (IMU) data as an output. The depth information and IMU information is usable to detect movements and rotations in about 3-10 degrees of freedom, or more specifically, about 6 degrees of freedom (or 6DoF). Further, in this example embodiment, each of the cameras 112 is oriented, as explained above, to provide a field of view of about 69 degrees horizontal, by about 112 degrees vertical (with about 7 degrees of overlap between the cameras 112). It should be appreciated that the horizontal field of view and the vertical field of view may be different in other embodiments.

Further, as is shown in FIG. 1, the cameras 112 are at a distance (e.g., distance d in FIG. 1, etc.) from one of the example plants 116 of the field 106, whereby the cameras 112 are configured to capture the distance d, as the depth of the object, i.e., the plant 116, along with images of the plant 116. In other embodiments, additional sensors may be included with the surveyor computing device 108 to determine the distance between the cameras 112 and the plants 116.

In connection with the above, the surveyor computing device 108 is also configured to, via one or more sensors, capture inertial measurement unit (IMU) data. The IMU data includes an angular rate and specific force/acceleration experienced by the surveyor computing device 108 as it traverses the rows of the field 106. In this example embodiment, the one or more sensors include an internal IMU in the camera 112 (e.g., the INTEL RealSense™ D435i camera, etc.), which includes a BOSCH BMI055 sensor with a 62.5 Hz accelerometer and 200 Hz gyro meter data rate.

While three cameras 112 are included and directed in one direction in the surveyor computing device 108, in the illustrated embodiment, to capture images of one row in the field 106, the surveyor computing device 108 in other embodiments may include a different number of cameras, including, for example, additional cameras directed in an opposite (or different) direction than the cameras 112 to capture image date of crops in an adjacent row, whereby images of two rows in the field 106 may be captured simultaneously. In still other embodiments, a surveyor computing device may be configured to be stationary or fixed in location, or mounted to a stationary structure (e.g., an arch structure to help facilitate desired positioning of the cameras 112 as described herein, etc.), whereby plants (e.g., disposed on trays, conveyors, carts, tracks, etc.) are identified by scanning a barcode, QR code, or other indicia to identify the plants (as compared to locations above), and then, the plants are moved relative to the surveyor computing device, whereby images of the plants are captured. The stationary surveyor computing device, in this example, may be more readily usable in a greenhouse, while the mobile surveyor computing device may be more readily useable in a field, etc. That said, it should be appreciated that the description herein is applicable to the stationary surveyor computing device to determine dimensions of the plants therein, despite the reversed relative movement.

With continued reference to FIG. 1, in this example embodiment, the surveyor computing device 108 includes a tracking sensor 118, which is configured to detect and/or determine a location in GPS denied conditions (of the surveyor computing device 108 (e.g., via WIFI signals or other techniques, etc.)), as the surveyor computing device 108 moves and/or at instances in which images are captured. The detected location data may be expressed, for example, as GPS-time coordinates (e.g., [latitude, longitude, time/date], etc.) or otherwise, etc. The surveyor computing device 108 may be further configured to associate or link the location data to the images captured by the cameras 112 (and other cameras) and/or the associated depth data. To this point, and as described more hereinafter, the tracking sensor 118 may aid performance, optionally, of de-duplication of the images. When performed, de-duplication permits the computing device 102 to limit images to aid in singular counting of ears of corn, for example, based on feature tracking and identity assignment via the tracking sensor 118.

It should be appreciated that other sensors may be included in the surveyor computing device 108, whereby the sensor(s) may be configured to detect and/or determine aspects of the corn plant 116 or field 106, the environment, and/or the surveyor computing device 108, etc.

As part of the above, it should also be appreciated that the surveyor computing device 108 is coupled in communication, via one or more networks, etc. (as indicated by the dotted lines), with the computing device 102. The one or more networks may include, without limitation, a local area network (LAN), a wide area network (WAN) (e.g., the Internet, etc.), a mobile network, a virtual network, and/or another suitable public and/or private network capable of supporting communication between the surveyor computing device 108 and the computing device 102, or a combination thereof. In one particular example, the one or more networks may include a mobile network, associated with a mobile network hotspot, which provides for real time communication between the surveyor computing device 108 and a mobile device (e.g., a tablet or other suitable computing device associated with a user, etc.).

In view of the above, from time to time, during growing of crops in the field 106, for example, the surveyor computing device 108 is configured to move through the field 106 and capture images of the corn plants 116, via the cameras 112. The images, in combination with the depth data (of the cameras 112 relative to the plants 116), the IMU data, and potentially also the location data for the surveyor computing device 108 is referred to herein in total as image data. In one or more embodiments, the surveyor computing device 108 is further configured to compile the image data from the cameras 112 and the different sensors and to communicate the image data to the computing device 102, which, in turn, is configured to store the image data in the database 104. The image data may be compiled and communicated at one or more regular or irregular intervals, or at the end of a row, or at the end of the field 106, or otherwise. The image data may be stored specific to the field 106, or stored relative to specific plants therein or otherwise, as desired or required.

In one or more embodiments, the surveyor computing device 108 is further configured to compile the image data from the cameras 112 and the different sensors and to store the compiled images therein. In such embodiments, the images remain, at least initially, in the surveyor computing device 108, wherein the computing device 102 (and the database 104) is (are) included in, at least in part, the surveyor computing device 108, whereby the configuration of the computing device 102 is applicable to the surveyor computing device 108. What's more, in this example embodiment (in which the computing device 102 (and the database 104) is (are) included in, at least in part, the surveyor computing device 108), download and upload times associated with transferring the images is avoided, or at least deferred, to accelerate proceeding with the processing described herein (e.g., to real time or near real time processing, etc.).

In addition to the image data, it should be appreciated that the database 104 may also include data related to the field 106, and, the plants 116 in the field 106. The data may include specific plant types, varieties, genetic profiles (e.g., trait stacks, etc.), management practices (e.g., treatments (e.g., fertilizers, fungicides, etc.), irrigation, tillage, etc.), identifiers unique to each of the plants, and location data for the particular plants, etc.

In this example embodiment, the computing device 102 (as a standalone computing device or as included in the surveyor computing device 108) is then configured to access the image data in the database 104, to identify ears of corn in the images of the corn plants 116 from the field 106 and to determine heights associated with the identified ears of corn of the corn plants.

In connection with the above, the computing device 102 is configured to pre-process the image data from the surveyor computing device 108 (for each image accessed), specifically, for example, to correct orientation of the given image (e.g., flip, rotate images, etc.), etc. In particular, for example, the computing device 102 may be configured to leverage a live feed of video from the cameras 112 to determine the correct orientation of the data capture. This may further leverage the IMU data for angular and linear moment from the origin calculations. That said, the pre-processing of the image data may include other operations, such as, for example, blurring or otherwise altering images based on the depth data associated with the images. For example, where the corn plant is known to be twenty-four inches from the surveyor computing device 108, and in particular, the cameras 112, the computing device 102 may be configured to blur the images outside of a depth of thirty inches from the camera 112, or some other threshold, etc., to limit the background on one or more models referenced herein. Pre-processing may also include stitching and/or aggregating images together from the cameras 112, and/or different images together based on location, or capture timing, to provide a singular image of the plants 116 of the row as the surveyor computing device 108 traverses the field 106. Alternatively, the raw image data may be aggregated or referenced together, based on a timestamp associated with the data. In one particular example of such aggregation, the raw image data may have *.bag format, where a ROS (Robot Operating System) may be used to capture the data from multiple sensors, together, and bag the data with corresponding time stamps (in the *.bag format). The bagged data may then be converted into a *.jpeg, *.ply, *.txt, etc. format based on the type of sensor(s) used to collect the data.

As part of the pre-processing for images used in training (e.g., training images, etc.), the computing device 102 is configured to prompt a user to annotate the images, for example, with an identification of the ear of corn and the node from which the ear emerges. The ear of corn and the node are identified by a bounding box imposed on the image by the user (e.g., through a mouse input, a touch screen input, etc.). In particular, the computing device 102 is configured to display the image to the user and to permit the user to draw the respective bounding box over the ear/node and to label the box (e.g., “ear,” “node,” etc.). The computing device 102 may be configured to prompt the user or multiple users to annotate one hundred, or three hundred, or more or less images, to thereby define a training set of images. It should be appreciated that a second user may verify the bounding boxes and/or labels prior to or after adding the images to the training set of images.

In this example embodiment, the computing device 102 is configured to then train a suitable model to perform ear and/or node detection based on the images.

In connection therewith, the computing device 102 may be configured to train a convolutional neural network (CNN) model with a part of the training set. The training involves exposing the input images and the output bounding boxes and labels to the model, while adjusting the parameters of the CNN to enable the CNN to produce the outputs from the inputs. Once trained, the computing device 102 may then be configured to append bounding boxes and/or labels to a series of validation images (i.e., another part of the training set without reference to their boxes/labels) and to validate the model based on matching the appended bounding boxes/labels against previously annotated boxes/labels for the images (and/or through manual inspection of the images, boxes, and labels, etc.), etc. When the model is trained and validated (e.g., provides a threshold level of accuracy, etc.), the computing device 102 may be configured to store the trained model in the database 104 for use as described below.

In this example embodiment, in particular, the CNN model includes a YOLOv5 (You Only Look Once Version 5) model (e.g., YOLOv5x, YOLOv5x6, etc.) (or other version of YOLO versions, etc.). The YOLOv5 model uses a convolution neural network (CNN) for object detection, which is configured to detect multiple objects, predict classes, and identify locations of an object. In one example, the configuration includes 53 CNN layers (Darknet53) stacked with 53 more layers producing 106 layers. In connection therewith, then, detections may take place at layers 82, 94, and 106. The model further uses convolutional layers instead of pooling layers, which may inhibit loss of low-level features.

More generally, the YOLOv5 network may include three parts: a backbone, which includes CNN layer aggregate image features at different scales; a neck, which includes a set of layers to combine image features and pass them forward to prediction; and a head, which takes features from the neck and performs localization and classification. As part of the above, in one example, the input images may be of any size and/or aspect ratio; the bounding box attributes may include an input (416, 416, 3), one or more deep CNN of the YOLOv5 model, a down sampling input image by stride 32, and a (13, 13, 255) feature map at scale 1. Further, training of the YOLOv5 model may include one or more ground truth bounding box for one (or more) object, a center cell assigned to predict the object(s), and a cell objectiveness of 1. And, detection may be performed a 82, 94, and 106 layers by 1×1 kernels applied to down sampled images, with feature maps of (13×13), (26×26), and (52×52).

It should be appreciated that the model may be trained again or updated at one or more intervals, based on additional training data for the same or different types, or varieties, of crops, etc.

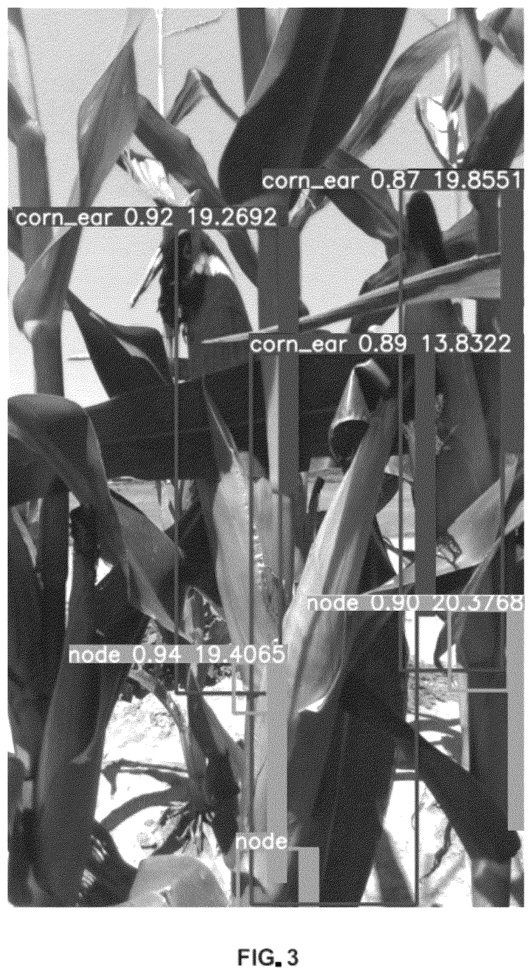

After the model is trained, validated and stored, in this example embodiment, the computing device 102 is configured to access image data from the database 104 (e.g., as captured by the cameras 112 and pre-processed as described above, etc.) and to provide the images to the trained model, whereby the computing device 102 is configured, by the trained model, to append bounding boxes to the images for the ears of corn included in the images. For each of the images, the bounding box(es) may include the ear of corn and/or may include the node of the ear of corn. FIG. 3, for example, illustrates an example input image with bounding boxes appended thereto by the trained model. The bounding boxes include both a bounding box for each visible ear of corn and also a bounding box for each visible node of the ears of corn in the image. In addition, as shown, the computing device 102 is configured, by the trained model, to append labels to and/or classifies the bounding boxes, i.e., corn_ear and node, respectively, in this example, as appropriate.

It should be appreciated that different bounding boxes for the ears and/or nodes, or different labels may be applied, by the model, in other embodiments.

The detection is based on overlap between the ear and node, in one or more embodiments. That is, a corn plant may potentially include numerous nodes, but less than all of the nodes are a location at which a corn ear is emerging. As such, detection of the ear and/or node includes detection of the ear and node, with at least some overlap therebetween, to confirm the detection of the ear of corn. In connection therewith, the node is identified for use in determining a height or other dimension of the ear of corn relative to the plant 116 and/or the ground.

With the ears of corn and nodes identified in the images, the computing device 102 is then configured to determine a specific height of the ears and/or nodes from the image data. In this example embodiment, the computing device 102 is configured to identify the location of the corn node, which is a center pixel or center coordinate of the bounding box for the node (which overlaps the ear bounding box), etc. It should be appreciated that another aspect of the bounding box for the node or the ear of corn may be identified as the “location” of the feature in other embodiment (e.g., a topmost pixel/coordinate, bottommost pixel/coordinate, average pixel/coordinate, etc.). The computing device 102 is configured to then access the depth data for the images, which were provided to the trained model, and to identify the depth data associated with a point of the bounding box (e.g., top, bottom, etc.) for the ear or the node, etc. The computing device 102 also is configured to access specific data for the surveyor computing device 108 including, for example, intrinsic data for the cameras 112, location of the cameras 112 (e.g., height of the cameras from the ground, distance between the camera and the plant plot etc.), and other suitable data, etc.

The computing device 102 is then configured to transform the coordinates of the point, using the depth data. In this example, x may represent the 2-dimensional pixel coordinates in the image, and X may represent the 3-dimensional coordinates of the ear or node (relative to the surveyor computing device 108), while K is the camera intrinsic matrix, which is indicative of aspects of the cameras 112. This is provided in the expression below.

$$[ \begin{matrix}x \\ y\end{matrix} ] = [ \begin{matrix}Fx & S & Cx \\ 0 & Fy & Cy \\ 0 & 0 & 1\end{matrix} ] [ \begin{matrix}X \\ Y \\ Z\end{matrix} ]$$

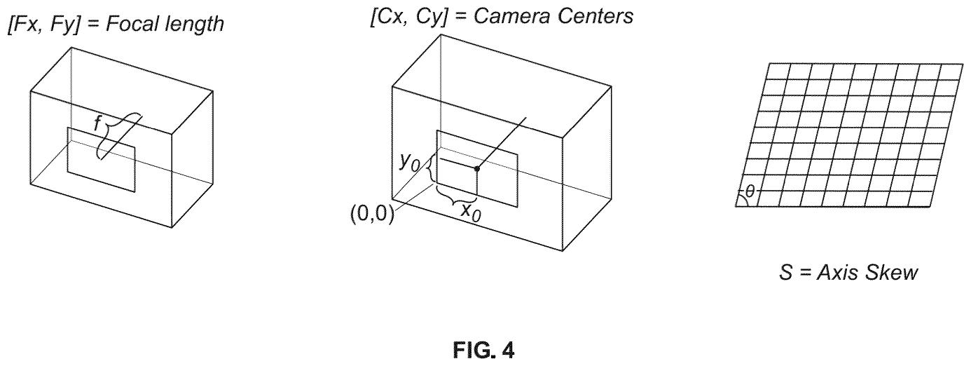

With reference to FIG. 4, the focal length is represented by Fx, Fy, and the camera centers are Cx, Cy, and the axis skew is S. From these variables, the computing device is configured to transform the coordinates of the point of the bounding box to the three-dimensional camera coordinate.

Next, in this example embodiment, the computing device 102 is configured to further transform the 3-dimensional camera coordinates from the camera origin to a world origin, based on the expression below, where the R matrix includes a rotation, as appropriate for the images, and the T matrix includes a translation, which accounts for movement of the cameras 112 as the images are captured.

$$[ \begin{matrix}R 1 & R 2 & R 3 \\ R 4 & R 5 & R 6 \\ R 7 & R 8 & R 9\end{matrix} ] * [ \begin{matrix}X \\ Y \\ Z\end{matrix} ] + [ \begin{matrix}T 1 \\ T 2 \\ T 3\end{matrix} ]$$

And finally, the computing device 102 is then configured to determine the ear height based on the transformed coordinates.

The computing device 102 (as a standalone computing device or as included in the surveyor computing device 108) is configured to output the ear height and/or node height. For example, with reference to FIG. 3, the computing device 102 may be configured to append the ear height and node height to the labels of the bounding boxes. As shown, in this example, the ear height may be measured in inches (or other units) and may include a confidence value. It should be understood that the height data may be output differently and/or presented otherwise to the user, as desired or required.

It should be appreciated that the computing device 102 may be configured to discard a height (or other dimension) closer to the ground when multiple heights share a relatively consistent location (e.g., based on GPS coordinates, etc.), as indicative of the ears being on the same plant, whereby only the highest ear height is retained.

Moreover, in connection with the above, it should be appreciated that a corn plant may be captured in multiple images. As such, the computing device 102 may be configured to perform de-duplication of the images, or the ear heights based on, potentially, the location of the plants, etc. De-duplication permits the computing device 102 to further count ears of corn in this embodiment, based on feature tracking and identity assignment. The counting leverages the images to provide accurate counting of ears to ensure reliable phenotypic measurements. Method can scale across traits and crops (i.e., beyond ear height or count) which may further ensure or promote precision in the classifications. The de-duplication approach may include, for example, simple online real-time tracking (SORT), BDP-Tile using GPS measurements, etc.

In one embodiment, the computing device 102 may be configured to average the ear height for the same plant, as determined from different images, etc., whereby only one value of the ear height for the plant is retained. It should be understood that other techniques for de-duplication of the ear height data (or the images) may be employed in other system embodiments.

While the description above is provided with reference to an ear of corn, or a node from which an ear of corn extends, it should be appreciated that other objects associated with the corn plant may be identified and the relative position of the same determined. For example, during pollination, bags may be placed over the ears of corn. The computing device 102, alone or as part of the or in combination with the surveyor computing device 108, may be configured to perform the above operation to determine height or other dimensions of the bags applied to the corn plants, and in particular, the ears of the corn plants. In addition to dimensions, a count of bags per plant, or bags per bench in a greenhouse, etc., or number of bags/ears per location may also be determined, etc.

In addition, while the description above is provided with reference to the surveyor computing device 108, as configured to move through the field 106 to capture images of plants 116 in the field 106, it should be appreciated that the features herein may be implemented in other devices. For instance, in one example embodiment, a combine may include the cameras 112 and the tracking sensor 118 mounted thereon (e.g., coupled to or mounted on a front portion of the combine, etc.) in similar configurations and/or arranges to those described above. The combine is then configured to move through the field 106 as generally described above with regard to the surveyor computing device 108 (such that, in some aspects, the combine may be considered as (or may represent) the surveyor computing device 108 illustrated in FIG. 1). In this way, data may be collected (via the cameras 112 and the sensor 118, etc.) from the field 106 as the combined moves through the field 106 harvesting the plants 116, etc.

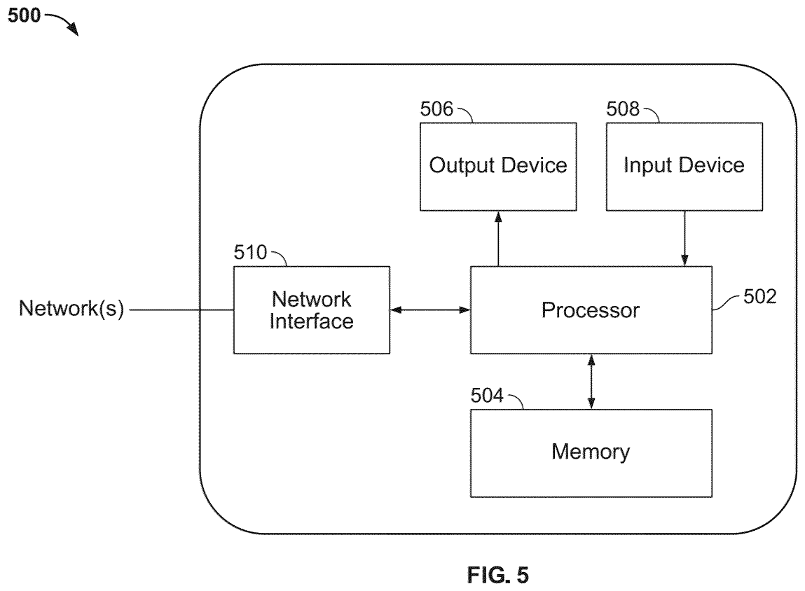

FIG. 5 illustrates an example computing device 500 that may be used in the system 100 of FIG. 1. The computing device 500 may include, for example, one or more servers, workstations, personal computers, laptops, tablets, smartphones, virtual devices, etc. In addition, the computing device 500 may include a single computing device, or it may include multiple computing devices located in proximity or distributed over a geographic region, so long as the computing devices are specifically configured to operate as described herein.

In the example embodiment of FIG. 1, the computing device 102 and/or the surveyor computing device 108 (e.g., including the cameras 112, sensors, etc.) include and/or are implemented in one or more computing devices consistent with computing device 500. The database 104 may also be understood to include and/or be implemented in one or more computing devices, at least partially consistent with the computing device 500. However, the system 100 should not be limited to the computing device 500, as described below, as different computing devices and/or arrangements of computing devices may be used. In addition, different components and/or arrangements of components may be used in other computing devices.

As shown in FIG. 5, the example computing device 500 includes a processor 502 and a memory 504 coupled to (and in communication with) the processor 502. The processor 502 may include one or more processing units (e.g., in a multi-core configuration, etc.). For example, the processor 502 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 504, as described herein, is one or more devices that permit data, instructions, etc., to be stored therein and retrieved therefrom. In connection therewith, the memory 504 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 504 is configured to store data including, without limitation, image data (e.g., images, depth data, etc.), models, parameters, phenotypic data, and/or other types of data (and/or data structures) suitable for use as described herein.

Furthermore, in various embodiments, computer-executable instructions may be stored in the memory 504 for execution by the processor 502 to cause the processor 502 to perform one or more of the operations described herein (e.g., one or more of the operations of method 600, etc.) in connection with the various parts of the system 100, such that the memory 504 is a physical, tangible, and non-transitory computer readable storage media. Such instructions often improve the efficiencies and/or performance of the processor 502 that is performing one or more of the various operations herein, whereby such performance may transform the computing device 500 into a special-purpose computing device. It should be appreciated that the memory 504 may include a variety of different memories, each implemented in connection with one or more of the functions or processes described herein.

In the example embodiment, the computing device 500 also includes an output device 506 that is coupled to (and is in communication with) the processor 502 (e.g., a presentation unit, etc.). The output device 506 may output information (e.g., bounding boxes, ear height, node height, etc.), visually or otherwise, to a user of the computing device 500, such as a researcher, grower, etc. It should be further appreciated that various interfaces (e.g., as defined by network-based applications, websites, etc.) may be displayed or otherwise output at computing device 500, and at output device 506, to display, present, etc. certain information to the user. The output device 506 may include, without limitation, a liquid crystal display (LCD), a light-emitting diode (LED) display, an organic LED (OLED) display, an “electronic ink” display, speakers, a printer, etc. In some embodiments, the output device 506 may include multiple devices. Additionally, or alternatively, the output device 506 may include printing capability, enabling the computing device 500 to print text, images, and the like on paper and/or other similar media.

In addition, the computing device 500 includes an input device 508 that receives inputs from the user (i.e., user inputs) such as, for example, metadata of the imaging secession, notes from the data collection, selections of crops, images, identifying ears/nodes, etc. The input device 508 may include a single input device or multiple input devices. The input device 508 is coupled to (and is in communication with) the processor 502 and may include, for example, one or more of a camera, a keyboard, a pointing device, a touch sensitive panel, or other suitable user input devices. It should be appreciated that in at least one embodiment the input device 508 may be integrated and/or included with the output device 506 (e.g., a touchscreen display, etc.).

Further, the illustrated computing device 500 also includes a network interface 510 coupled to (and in communication with) the processor 502 and the memory 504. The network interface 510 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), including one or more network or other suitable network capable of supporting wired and/or wireless communication between the computing device 500 and other computing devices, including with other computing devices used as described herein (e.g., between the computing device 102, the database 104, etc.).

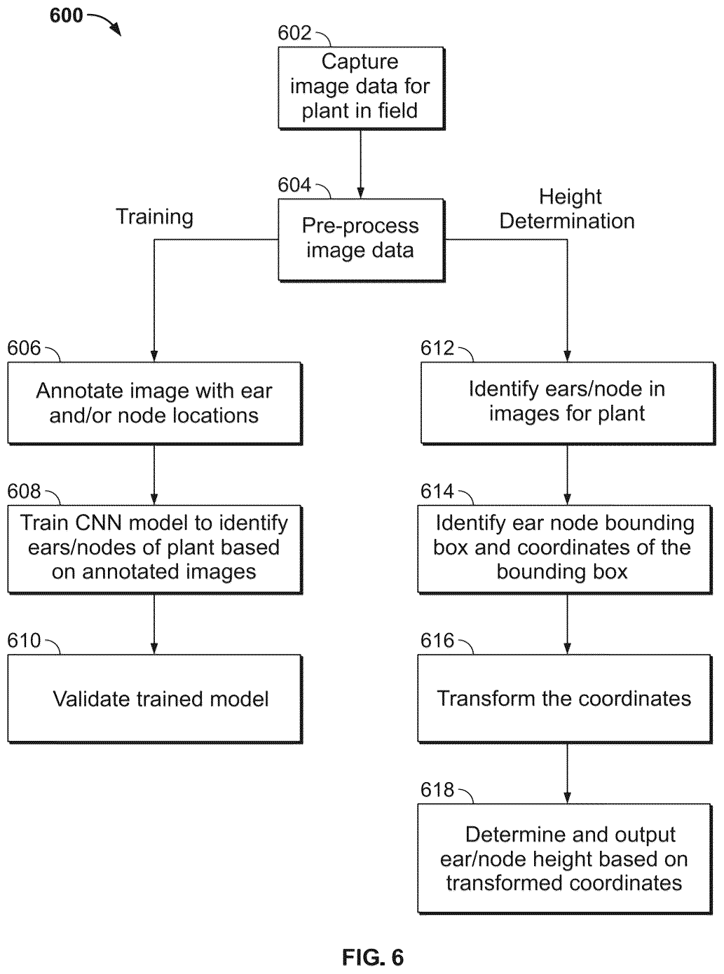

FIG. 6 illustrates an example method 600 for processing image data for crops, which includes position data, whereby positions of specific points related to the crops are determined. The example method 600 is described herein in connection with the system 100, and may be implemented, in whole or in part, in the computing device 102 of the system 100, which may be implemented as a standalone computing device or as included in the surveyor computing device 108 in connection with method 600. Further, for purposes of illustration, the example method 600 is also described with reference to the computing device 500 of FIG. 5. However, it should be appreciated that the method 600, or other methods described herein, are not limited to the system 100 or the computing device 500. And, conversely, the systems, data structures, and the computing devices described herein are not limited to the example method 600.

At 602, the surveyor computing device 108 captures image data associated with the plant 116 in the field 106 (as shown in FIG. 1). The image data includes one or more images of the corn plant 116, a location of the surveyor computing device 108 at capture of that one or more images, and depth data also captured by the surveyor computing device 108. It should be appreciated that other data may be included in the image data, such as, for example, sensor data, environmental data, etc.

In connection therewith, the image data is communicated from the surveyor computing device 108 to the computing device 102 (and/or the database 104) (for embodiments in which it is separate therefrom).

Next, the image data is pre-processed, at 604. In particular, in this example, the one or more images are rotated or flipped, as desired, and potentially stitched together to provide a singular image of the plant 116. In one or more examples, pre-processing includes de-duplication of the images to limit the number of occurrences of the plant 116 in the images (e.g., to only a single occurrence, etc.), as explained above in more detail.

In one or more examples, background detail in the images may be blurred, removed, or otherwise reduced to avoid or limit the exposure of any background plants to the steps described below. In particular, for example, the computing device 102 may use depth information from the cameras 112 to threshold out anything in the adjacent rows (e.g., closer and/or farther from the cameras 112, etc.) in order to aid in avoiding deletions in the rows that are not the point of interest, which may, in turn, reduce or eliminate error in processing for height calculations.

The pre-processed image data is then stored in memory (e.g., the database 104, etc.).

In connection with a training phase, as indicated in FIG. 6, the pre-processed images are displayed to a user, such as a researcher or grower, etc., at the computing device 102 or other suitable computing device, and the user annotates, at 606, the specific points of the plant in an image, which in this example, includes the ears of corn and/or nodes, from which the ears of corn emerge. The annotation may include, for example, placing bounding boxes over or around the whole ear of corn (or a substantial portion thereof) and around the node (or a substantial portion thereof). There may be multiple bounding boxes annotated into each image. In addition to the bounding box(es), the user classifies a label, such as, for example, ear or node to designate that the bounding box indicates an ear or a node. It should be appreciated that step 606 may include annotating dozens, or hundreds or even thousands of images, as part of the training phase, to define a training set of images. The annotations are then saved with the images.

At 608, the computing device 102 then trains a CNN model, in this example, based on the annotated images, to identify the ear and/or nodes of plants. The training may include fifty, sixty, seventy or eighty percent of the annotated images, or more or less, etc.

Thereafter, at 610, the computing device 102 validates the trained model based on the remainder of the annotated images. Specifically, the computing device 102 provides the image (without the annotations) to the trained model and compares the ear/node identified by the model (e.g., via bounding boxes, etc.) with the annotations to the input image. When the performance of the trained model is sufficient, or satisfies one or more thresholds, the trained model is validated and stored (e.g., in memory 504, etc.) for use in the height determination phase.

While the CNN model is trained in method 600, it should be appreciated that other suitable models may be employed in other method embodiments, as suggested above.

In the height determination phase, as above, images are captured and pre-processed at steps 602 and 604, as applicable. At 612, the computing device 102 identifies the ears/nodes, or more broadly, features, of the plant in the image(s) for the plant based on the trained model. That is, the computing device 102 provides the images (i.e., pre-processed images) of the plant to the trained model and the train model identifies, by bounding boxes, each feature of the plant, where the features are ears and/or nodes.

The output of the model includes the bounding boxes for the different features, as shown, for example, in FIG. 3 by the four bounding boxes for the two nodes and the two ears of corn (but, without the height labels).

At 614, the computing device 102 initially identifies overlap between a node bounding box and an ear bounding box, which is indicative of an emergence feature of the plant 116. Further, at 614, the computing device identifies central coordinates (or other coordinates) of the bounding box for the node. In other embodiments, the coordinates may be of the ear bounding box, or other coordinates of the node bounding box. For example, the coordinates may include topmost coordinates, bottommost coordinates, average coordinates, etc., or other coordinate of either or both of the node bounding box and the ear bounding box. It should be appreciated that the specific coordinates may vary within the specific bounding boxes, but will generally be consistent for multiple plants to provide an indication of relative dimension(s) between the plants.

With the coordinates for the specific features and the depth data and other data included in the image data for the image including the bounding box, the computing device then transforms, at 616, the coordinates. In particular, a specific point of the bounding box, such as, for example, a top point or bottom point is correlated with the image and depth data for the image. The point in the image is expressed as coordinates, and the coordinates are then transformed, using the depth data, as generally described above in the system 100.

At 618, the computing device 102 determines the height of the point, or in this specific instant, the ears and/or nodes of the corn plant included in the image, and then outputs the heights to the user. The determination is based on the transformed coordinates, the height of the camera from the ground, etc. In connection therewith, the computing device 102 further annotates the image with the height of the features, and in particular, the ears and nodes, for example, as shown in FIG. 3. While the height is determined herein, one or more other dimensions of the plant may be determined consistent with the description herein.

It should be appreciated that when the computing device 102 is integrated, in whole or in part, with the surveyor computing device 108, the height determination is accomplished in real-time (e.g., in less than one minute from capture, etc.), or near real time (e.g., within about one minute, two minutes, or up to five minutes, etc.), etc. In connection therewith, the computing device 102 may limit the resolution of the captured images (e.g., reduce the resolution of the RGB image by 50%, or more or less, etc.), skip images (e.g., skip every other, or two in three images, etc.), apply multi-threading, reduce image capture frequencies, or implement other manners of reducing data to be processed to aid in achieving desired throughput from image capture to height determination, etc.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing image data specific to a corn plant, the image data including an image of the corn plant and depth data indicative of a range between the corn plant and a camera, which captures said image; (b) identifying, using a trained model, a feature of the corn plant, the feature including an ear of the corn plant and/or a node from which the ear emerges; (c) transforming coordinates specific to the feature into a height of the feature of the corn plant; (d) storing the height of the feature of the corn plant in a memory; (c) pre-processing the image prior to identifying the feature of the corn plant; and (f) appending the height to the feature on the image.

As will also be appreciated based on the foregoing specification, the above-described embodiments of the disclosure may be implemented using computer programming or engineering techniques, including computer software, firmware, hardware or any combination or subset thereof, wherein the technical effect may be achieved by further (e.g., additionally to the above listing, alternatively to the above listing, etc.) performing at least one of the following operations: (a) accessing image data specific to a plant, the image data including an image of the plant and depth data indicative of a range between the plant and a camera, which capture said image; (b) identifying, by a computing device, using a trained model, a feature of the plant; (c) transforming, by the computing device, coordinates specific to the feature into a dimension of the feature of the plant; and (d) storing, by the computing device, the dimension of the feature of the plant in a memory.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing image data for crops, the method comprising:
accessing image data specific to a corn plant, the image data including an image of the corn plant and depth data indicative of a range between the corn plant and a camera, which captures said image;
identifying, by a computing device, using a trained model, a feature of the corn plant, the feature including an ear of the corn plant and/or a node from which the ear emerges;
transforming, by the computing device, coordinates specific to the feature into a height of the feature of the corn plant; and
storing, by the computing device, the height of the feature of the corn plant in a memory.

2. The computer-implemented method of claim 1, wherein the trained model includes a convolutional neural network (CNN) model; and
wherein the feature of the corn plant includes the ear of the corn plant and the node from which the ear emerges.

3. The computer-implemented method of claim 1, further comprising pre-processing the image prior to identifying the feature of the corn plant; and/or
wherein identifying the feature of the corn plant includes:
identifying a first bounding box for the ear of corn plant and a second bounding box for the node from which the ear emerges;
confirming overlap between the first bounding box and the second bounding box; and
identifying coordinates of a center of the second bounding box for the node as said coordinates specific to the feature.

4. The computer-implemented method of claim 3, wherein transforming the coordinates specific to the feature includes:
transforming 3-dimensional coordinates of the first and second bounding boxes, via an intrinsic matrix, to 2-dimensional homogeneous image.

5. The computer-implemented method of claim 4, wherein transforming the coordinates specific to the feature includes:
translating/rotating the 3-dimensional coordinates of the first and second bounding boxes based on a transformation between a camera origin and a world origin.

6. The computer-implemented method of claim 1, wherein transforming the coordinates specific to the feature into a height of the feature further includes determining the height relative to a ground based on the coordinates.

7. The computer-implemented method of claim 1, further comprising appending the height to the feature on the image, whereby the height is illustrated with the feature on the image.

8. A non-transitory computer-readable storage medium including executable instructions for processing image data, which when executed by at least one processor, cause the at least one processor to:
access image data specific to a plant, the image data including an image of the plant and depth data indicative of a range between the plant and a camera, which captured said image;
identify, using a trained model, a feature of the plant, the trained model including convolutional neural network (CNN) model;
transform coordinates specific to the feature into a height dimension of the feature of the plant; and
store the dimension of the feature of the plant in a memory.

9. A system for use in processing image data for crops, the system comprising:
a memory; and
a computing device coupled to communication with the memory, the computing device configured to:
access image data specific to a corn plant, the image data including an image of the corn plant and depth data indicative of a range between the corn plant and a camera, which captures said image;
identify, using a trained model, a feature of the corn plant, the feature including an ear of the corn plant and/or a node from which the ear emerges;
transform coordinates specific to the feature into a height of the feature of the corn plant; and
store the height of the feature of the corn plant in the memory.

10. The system of claim 9, wherein the computing device includes a surveyor computing device, which includes one or more cameras; and
wherein the surveyor computing device is configured to capture the image data specific to the corn plant, via the one or more cameras.

11. The system of claim 9, wherein the trained model includes a convolutional neural network (CNN) model, which includes a YOLOv5 (You Only Look Once Version 5) model.

12. The system of claim 9, wherein the trained model includes a YOLOv5 (You Only Look Once Version 5) model.

13. The system of claim 9, wherein the feature of the corn plant includes the node from which the ear of the corn plant emerges.

14. The system of claim 9, wherein the computing device is further configured to pre-process the image prior to identifying the feature of the corn plant, prior to identifying the feature, via the trained model; and
wherein the computing device is configured, in identifying the feature, to:
identify a first bounding box for the ear of corn plant and a second bounding box for the node from which the ear emerges;
confirm overlap between the first bounding box and the second bounding box; and
identify coordinates of a center of the second bounding box for the node as said coordinates specific to the feature.

15. The system of claim 14, wherein the computing device is configured, in transforming the coordinates specific to the feature, to:
transform 3-dimensional coordinates of the first and second bounding boxes, via an intrinsic matrix, to 2-dimensional homogeneous image.

16. The system of claim 15, wherein the computing device is configured, in transforming the coordinates specific to the feature, to:
translating/rotating the 3-dimensional coordinates of the first and second bounding boxes based on a transformation between a camera origin and a world origin.

17. The system of claim 9, wherein the computing device is configured, in transforming the coordinates specific to the feature, to determine the height relative to a ground based on the coordinates.

18. The system of claim 9, wherein the computing device is further confirmed to append the height to the feature on the image, whereby the height is illustrated with the feature on the image.
